(19) United States
(12) Patent Application Publication
(10) Pub. No.: US 2006/0250204 A1
(43) Pub. Date: Nov. 9, 2006

(54) Magnet configuration with device for attenuation of voltage spikes of a power supply and method for operation thereof

(75) Inventors: Rolf Spreiter, Zuerich (CH); Robert Schauwecker, Zuerich (CH)

Correspondence Address: KOHLER SCHMID MOEBUS, RUPPMANNSTRASSE 27, D-70565 STUTTGART, DE

(73) Assignee: Bruker BioSpin AG, Faellanden (CH)

(21) Appl. No.: 11/414,193

(22) Filed: May 1, 2006

(30) Foreign Application Priority Data
May 3, 2005 (DE) 10 2005 020 690.5

(51) Int. Cl. H01F 6/00

(52) U.S. Cl. 335/216

(57) ABSTRACT

A magnet configuration comprising a superconducting magnet coil system (M) which has a working volume and an ohmic resistance (R) of zero or more, and a current path (P) which comprises parts of the magnet coil system (M), with connecting points (AP1, AP2), a power supply (PS, PS′), and an electric network (D1, D1′, D2), wherein the connecting points (AP1, AP2) of the current path (P) are electrically connected to connections (AD1, AD2, AD1′, AD2′) of an electric network (D1, D1′, D2) facing away from the power supply, and the power supply (PS, PS′) is electrically connected to connections (AD3, AD4) on the power supply side of the electric network (D1), and wherein the network (D1, D1′) comprises a resistance (R1), is characterized in that the network (D1, D1′) comprises an inductance (L1), wherein the connections (AD1, AD2) are connected to each other via the resistance (R1), and the connections (AD3, AD4) are connected to each other via the resistance (R1) and the inductance (L1). This improves attenuation of the field fluctuations such that the voltage that is effectively applied across the magnet is sufficiently constant to prevent disturbance of high-resolution NMR and MRI methods.

This application claims Paris Convention priority of DE 10 2005 020 690.5 filed May 03, 2005 the complete disclosure of which is hereby incorporated by reference.

### BACKGROUND OF THE INVENTION

The invention concerns a magnet configuration comprising a superconducting magnet coil system having a working volume and an ohmic resistance of zero or more during operation, and having at least one current path which comprises at least parts of the magnet coil system, with connecting points, a power supply and at least one electric network, wherein the connecting points of the current path are electrically connected to connections of at least one electrical network, facing away from the power supply, and the power supply is electrically connected to connections of the electric network on the power supply side, and wherein the network comprises at least one resistance.

A magnet configuration of this type is disclosed in US 2003/0057942 A1.

Magnet configurations comprising a superconducting magnet coil system are used, in particular, for magnetic resonance measurements (NMR) which require a very stable magnetic field.

Superconducting magnet systems for high-resolution NMR are usually operated in the “persistent” mode, i.e. the circuit is short-circuited, so that an active power supply is no longer required as soon as the magnet has been charged. To ensure that the magnetic drift (current reduction with time) is sufficiently small, the wires and wire connections must meet very high requirements with regard to residual resistance.

Superconducting wires have no distinct transition between the superconducting and the normally conducting states. If the wires bear high currents, one obtains an ohmic resistance of more than zero for the magnet coil system. This is particularly the case for high field magnets and, in particular, when high-temperature superconductors are used. In these cases, a persistent mode having the required stability is either no longer possible or is uneconomical. As a result, measures must be taken to compensate for these resistive losses.

Conventionally, power supplies are used which couple energy into the magnet coil to compensate for these resistive losses of the magnet coil. Such supplies are also used for charging or discharging magnet coils.

US 2003/0057942 A1 discloses a magnet configuration with a superconducting magnet coil system and a conventional current source as the power supply. The conventional device provides a network having a resistance, which is connected in parallel to the magnet in order to attenuate the current fluctuations in the magnet caused by insufficient stability of the current source. This type of device achieves the desired attenuation only when a continuous current supply having a conventional current source is used. However, conventional current sources used as power supplies generate large heat input into the cryostat due to the large currents that flow into the cryostat. This renders stable operation of the magnet configuration more difficult.

The heat input into the cryostat can be reduced by using flux pumps as power supplies. Energy is thereby inductively coupled into the magnet coil of the magnet coil system. Conventional flux pumps are, however, not suited for use in precise field stabilization over long time periods, since the charging voltage generated by the flux pump is usually not constant with time. Moreover, voltage spikes can occur when the switches are opened and most methods include interruption and periodic fluctuations in the generated voltage. These disturbances and periodically fluctuating voltages result in field fluctuations of the magnet system and cannot be tolerated for sensitive applications such as high-resolution magnetic resonance methods, since they interfere with or even prohibit the high-resolution NMR measurements.

A magnet configuration comprising a superconducting magnet coil system and a power supply (flux pump) is disclosed in U.S. Pat. No. 2,150,291, by T. P. Bernart et al., Rev. Sci. Instrum., Vol. 46, No. 5, May 1975, pages 582 to 585, and also by L. J. M. van de Klundert et al., Cryogenics, April 1981, pages 195 to 206.

It is the object of the present invention to improve a magnet configuration of prior art having a superconducting magnet coil system and a power supply (e.g. flux pump) with regard to attenuation of the field fluctuations that reach the magnet due to the power supply, such that, despite the above-mentioned fluctuations in the generated voltage, the voltage which is effectively applied to the magnet is sufficiently constant that e.g. high-resolution NMR and MRI methods can be carried out.

### SUMMARY OF THE INVENTION

This object is achieved in accordance with the invention in that the network comprises at least one inductance, wherein the connections facing away from the power supply are connected to each other via at least the resistance and the connections on the power supply side are connected to each other via at least the resistance and the inductance.

This configuration smoothes power supply voltage changes, so that a nearly constant average voltage value is applied across the magnet and e.g. high-resolution NMR measurements can be performed. The fluctuating energy supply is smoothed, with energy being intermediately stored in the superconducting coils and then slowly and, with appropriate design, practically continuously, discharged to the magnet system. The network that connects the power supply to the magnet system thereby acts as a low pass filter.

Moreover, voltage spikes can also be attenuated in a highly effective manner. The precise construction of the power supply is thereby relatively unimportant. The inventive configuration therefore represents an improvement for all types of power supplies.

In a preferred embodiment of the inventive magnet configuration, at least two networks are connected between the connecting points of the current path and the power supply in such a manner that the connections of the first network, facing away from the power supply, are connected to the connections on the power supply side of the second network, wherein the second network comprises at least one inductance and the second network connections facing away from the power supply are connected to each other via at least one resistance, with the connections on the power supply side being connected to each other via at least the resistance and the inductance. The filtering effect can, in principle, be increased through use of an appropriate number of networks until the voltage fluctuations no longer disturb the measurements.

At least one of the inductances of at least one of the networks is preferably formed by a superconducting coil. Superconducting coils produce no additional losses which must be compensated for by the power supply. Furthermore, large time constants can be achieved with superconducting coils to thereby improve the filtering effect.

In one embodiment of the magnet configuration, the power supply is an active current source (driven mode). In this case, the inventive configuration has a stabilizing effect, i.e. fluctuations of the current source can be greatly attenuated and no longer disturb e.g. sensitive NMR measurements.

In one preferred embodiment, the power supply is a flux pump. The present invention permits, for the first time, use of a flux pump as an active power supply e.g. for a high-resolution NMR system, since the nearly unavoidable voltage spikes are attenuated to such an extent that they are no longer disturbing. It is thereby possible to develop stronger and more compact magnet systems.

In an advantageous manner, at least one of the inductances of at least one of the networks is, to a great extent, inductively decoupled from the magnet coil system. This can be achieved by a corresponding spatial configuration of the coils and prevents transmission of disturbances into the magnet via inductive coupling.

In a further advantageous manner, at least one of the inductances of at least one of the networks is arranged in such a manner that its stray field in the working volume is minimized. This prevents disturbances of the sensitive NMR measurements due to changes in the stray field of the coils.

In a special embodiment of the inventive magnet configuration, at least one of the inductances of at least one of the networks comprises a coil having a shielding winding which minimizes its stray field. The shielding winding reduces the stray field as well as the sensitivity of the overall configuration to external magnetic disturbances to thereby prevent disturbances caused by current fluctuations in the coil.

When at least two networks are provided, at least two of the inductances each advantageously comprises at least one coil, the coils being spatially arranged in such manner that their overall field in the working volume is minimized. Mutual compensation of the stray fields of the individual coils minimizes the overall stray field such that the magnet configuration is less sensitive to external disturbances.

The time constant L/R of the network is preferably of the same order of magnitude or larger than the time duration of the largest fluctuation amplitude of the voltage or current of the power supply. It is thereby possible to achieve sufficient smoothing and adequate attenuation of disturbances in this region.

In an advantageous embodiment of the inventive magnet configuration, a switch is connected in series with at least the resistance of the network. Attenuation is rendered inoperative by opening the switch. This may be required for charging or discharging, since the currents flowing through the resistances in the network would otherwise be too large. The possibility of switching off the filtering elements also greatly facilitates setting of the parameters of a flux pump as the voltage source.

In a particularly advantageous embodiment of the inventive magnet configuration, the switch is disposed outside of the cryostat in the room temperature region. A filtering element can thereby be deactivated without increasing the heat input into the cryostat.

The switch is preferably a superconducting switch. With the use of a superconducting switch for deactivating a filtering element, the resistances in the filtering element may be very small when the switch is closed, and large filter time constants can be achieved with small coils.

In a further advantageous embodiment of the inventive magnet configuration, a superconducting current limiter is connected in series with at least the resistance of the network. The superconducting current limiter is used instead of a switch for deactivating a filtering element. If the current becomes too large, e.g. during charging of the magnet system, the filtering elements are automatically deactivated without having to provide additional wires into the cryostat.

The inventive configuration is particularly advantageous when the superconducting magnet coils system is part of an apparatus for nuclear magnetic resonance. The devices for active field stabilization of such magnet configurations must meet particularly stringent requirements with regard to the stability of the stabilization voltage and minimization of the heat input into the cryostat. The above-mentioned configuration of the flux pump with filter network and superconducting magnet system fulfils these criteria to a better extent than conventional configurations.

In a particularly advantageous embodiment of the inventive magnet configuration, the superconducting magnet coil system comprises one or more high-temperature superconductor coils. The potentially higher drift obtained through use of high-temperature superconductors can be compensated for with the inventive attenuating configuration using a flux pump, thereby maintaining the field stability of the superconducting magnet coil system.

The invention also concerns a method for operating the above-described magnet configuration, wherein, for charging the superconducting magnet coil system, at least the superconducting switch of the network is heated to prevent excessive cross-currents from flowing through the resistances and producing an excessive amount of heat.

The excitation current of the power supply is preferably adjusted in such a manner that the magnetic drift caused by the resistance of the magnet system is largely compensated for, in particular, such that the power supply current is larger than the current in the current path P.

It is also advantageous to adjust a pulsed or time-varying power supply voltage in such a manner that its average voltage largely compensates for the drift caused by the resistance of the magnet system.

Further advantages of the invention can be extracted from the description and the drawing. The features mentioned above and below may be essential to the invention either individually or collectively in arbitrary combination. The embodiments shown and described are not to be understood as exhaustive enumeration but have exemplary character for describing the invention.

### BRIEF DESCRIPTION OF THE DRAWING

FIG. 1 shows a circuit diagram of an inventive magnet configuration comprising a power supply, a network for attenuating voltage spikes and a superconducting magnet coil system;

FIG. 2 shows a circuit diagram of an inventive magnet configuration comprising a flux pump as the power supply;

FIG. 3 shows a circuit diagram of an inventive magnet configuration comprising a flux pump as power supply, and two inventive networks;

FIG. 4 shows a circuit diagram of an inventive network with a switch; and

FIG. 5 shows a circuit diagram of an inventive network with a superconducting current limiter.

### DESCRIPTION OF THE PREFERRED EMBODIMENT

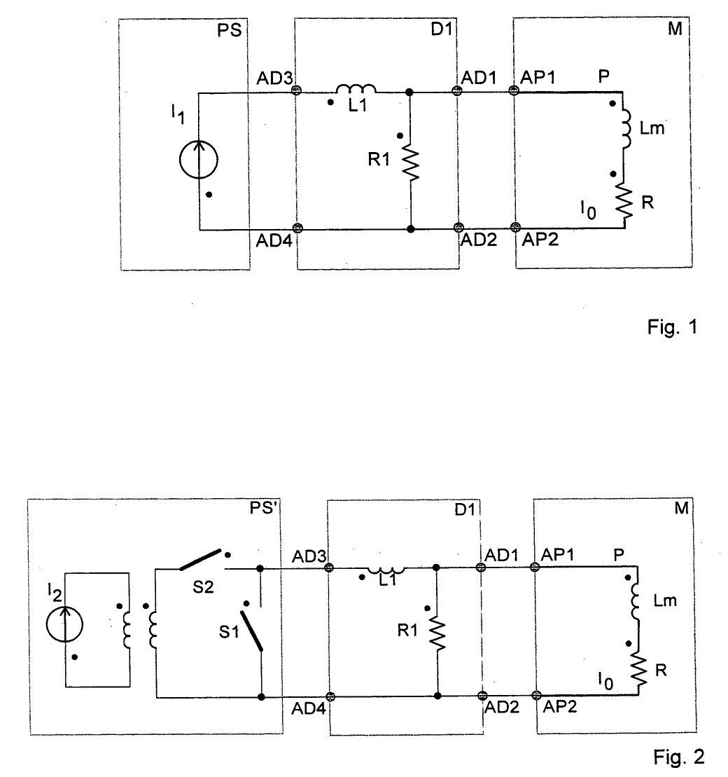

FIG. 1 schematically shows an inventive configuration, which comprises a superconducting magnet coil system M with a superconducting coil Lm, a power supply PS and an inventive network D1 for attenuating voltage spikes. The magnet coil system M has a resistance R that is shown as an equivalent resistance in the circuit diagram. The magnet coils system M is connected to a power supply PS via connecting points AP1, AP2 of a current path P and via the network D1. The power supply PS feeds current I1 to the magnet coil system M via the network D1. The network D1 is connected to the power supply PS via network D1 connections AD3, AD4.

The network D1 comprises an inductance L1 and a resistance R1. The connections AD1, AD2 of the network D1, facing away from the power supply PS, are connected to each other via the resistance R1, whereas the connections AD3, AD4 on the power supply side are connected to each other via the resistance R1 and the inductance L1. This inventive design of the network D1 permits intermediate storage of energy in the inductance L1 during fluctuating energy supply by the power supply PS, which is then continuously supplied to the magnet system to realize a temporally more constant energy supply into the magnet coil system M.

FIG. 2 shows an inventive magnet configuration with a flux pump as power supply PS′, which comprises switches S1, S2. The flux pump generates a periodically fluctuating voltage across the connecting points AD3 and AD4 of the network D1 during operation via periodic variations of the current I2. Moreover, actuation of the switches S1, S2 produces voltage spikes. The inventive network D1 smoothes these voltages such that substantially only the temporal average voltage is applied across the magnet coil system M. The non-continuous voltage of the flux pump is filtered through attenuation by the network D1 to such an extent that the voltage applied across the magnet system M is sufficiently constant that the inventive configuration can be used to perform e.g. sensitive nuclear magnetic resonance experiments.

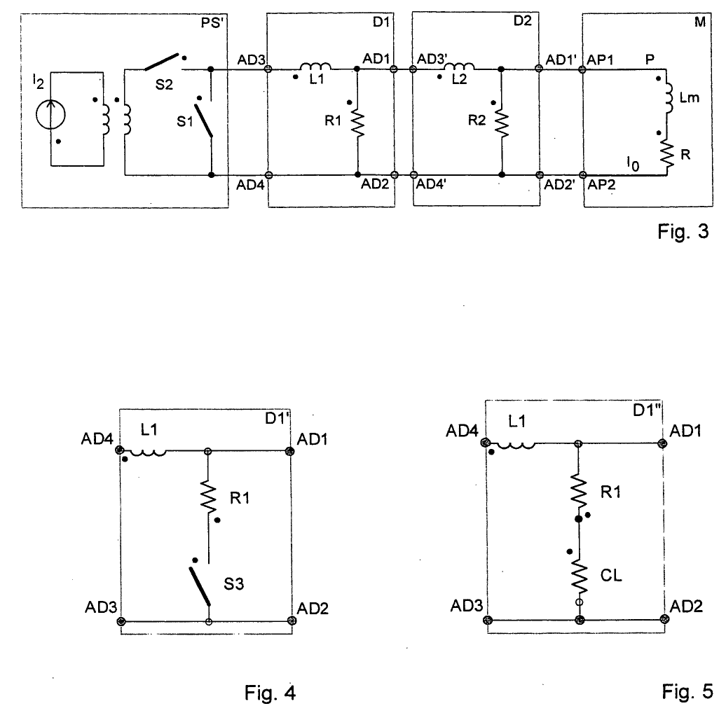

FIG. 3 shows an embodiment of the inventive magnet coil system comprising a further network D2 which is connected in series with the network D1. The first network connections AD1, AD2, facing away from the power supply, are connected to connections AD3′, AD4′ on the power supply side of the second network D2, wherein the network D2 connections AD1′, AD2′, facing away from the power supply, are connected to each other via a second network D2 resistance R2, and the connections AD3′, AD4′ on the power supply side are connected to each other via the resistance R2 and an inductance L2. A series connection of two or more networks D1, D2 of this type increases the attenuation properties of the overall configuration.

FIG. 4 shows an embodiment of an inventive network D1′ comprising a switch S3. The filtering function of the network D1′ can be switched off by opening the switch D3. This is required e.g. for charging and discharging the magnet configuration M, and simplifies adjustment of the parameters of a flux pump used as power supply PS′.

FIG. 5 shows an embodiment of an inventive network D1″ comprising a superconducting current limiter CL. If the current through the current limiter CL rises above a certain threshold value, it becomes highly resistive and the filtering element is deactivated to prevent occurrence of high currents in the filtering element during charging and discharging of the magnet.

The invention is explained below with reference to an example.

An NMR magnet of a field strength corresponding to a proton resonance frequency of f₀=600, a magnet current of I₀=130 A, and an inductance of L=150 Henry is used. The magnet is slightly resistive which causes a drift of d=0.306 Hz/s. A supportive voltage of

$${U}_{s} = d \frac{{LI}_{0}}{{f}_{0}} = 10 μ V$$

is required to compensate for this drift.

A power supply that generates this constant voltage on a permanent basis would be ideal. Real flux pumps, however, operate in cycles and normally generate periodic voltages. In the present example, we assume that a flux pump is operated with a period of 600 s, wherein it generates a voltage of 20 μV during half the time, using the remaining time for regeneration.

In accordance with prior art without inventive attenuation, the magnet is “loaded” during the support phase with +0.306 Hz/s to drift with −0.306 Hz/s during the regeneration phase. On a long-term average, the field remains constant but the magnetic frequency will vary by 92 Hz during a cycle, which cannot be accepted for high-resolution NMR spectroscopy.

The following shows the reduction of the magnetic frequency fluctuation during a cycle of the flux pump to a value of <0.1 Hz, which is acceptable for high-resolution NMR, through attenuation using the configuration of the inventive networks.

The embodiment of the inventive configuration taken as a basis for this example corresponds, in principle, to FIG. 3 but has four, and not two, networks D1, D2, D3, D4 which are connected in series. For reasons of simplicity, the four inductances L1, L2, L3, L4, and the four resistances R1, R2, R3, R4 of the four networks D1, D2, D3, D4 are identical in this example.
L1=L2=L3=L4=L
R1=R2=R3=R4=R

The circuit can be most easily analyzed in the frequency domain. The magnitude of the voltage transmission function in frequency space yields, in complex form and with τ=L/R:

$$\vert F ( ω ) \vert = \vert \frac{{U}_{a}}{{U}_{e}} ( ω ) \vert = \frac{1}{\vert 1 - 10 ⅈ τ ω - 15 {τ}^{2} {ω}^{2} + 7 ⅈ {τ}^{3} {ω}^{3} + {τ}^{4} {ω}^{4} \vert} \qquad ( 1 )$$

Since the voltage Uₑ(t) generated by the flux pump is periodic with a period duration T, it can be represented as a Fourier series:

$${U}_{e} ( t ) = \frac{{a}_{0}}{2} + {\sum }_{n = 1}^{∞} ( {a}_{k} cos n ω t + {b}_{k} sin n ω t ) . \qquad ( 2 )$$

a₀/2=10 μV is the average temporal value of the voltage generated by the flux pump which is transferred without attenuation in the stationary state according to formula (1). The largest Fourier component is that of frequency ω=2π/T having the amplitude:
U_{p,ω}=2a₀/π=12.73 μV

The Fourier component U_{p,ω} generates a fluctuation amplitude in the magnetic frequency of:

$${f}_{ω} = \frac{{f}_{0} {U}_{p , ω}}{{I}_{0} ω L} .$$

For high-resolution nuclear magnetic resonance applications, a maximum field fluctuation of 0.1 Hz can be tolerated, i.e.:

$$0.1 Hz > \frac{{f}_{0} {U}_{p , ω}}{{I}_{0} ω L} F ( ω )$$

and hence F(ω)<2.67×10⁻³

From formula (1), one obtains τ>2340 s for the filter time constant. A time constant of such great length can be realized e.g. with a superconducting coil of 10 mH and a resistance of 4.3 μΩ.

This example of an inventive magnet configuration shows the advantages with respect to the filtering effect of the electric networks in connection with the use of a flux pump as a power supply.

Although the voltage generated by the flux pump may greatly fluctuate, the inventive magnet configuration can still keep the effective voltage applied across the magnet at a constant value. Attenuation of the current and voltage fluctuations of the power supply PS, PS′ is improved such that a current I₀ flows in the current path (P) which is sufficiently constant to prevent disturbance of e.g. high-resolution NMR and MRI methods.

### LIST OF REFERENCE NUMERALS

AD1, AD2 connections of the first network, facing away from the power supply

AD1′, AD2′ connections of the second network, facing away from the power supply

AD3, AD4 connections of the first network on the power supply side

AD3′, AD4′ connections of the second network on the power supply side

D1,D1′,D1″ first network

D2 second network

I1, I2 current of the power supply

I₀ current in the current path P

L1 inductance of the first network

L2 inductance of the second network

Lm superconducting coil

M magnet coil system

P current path

PS,PS′ power supply

R resistance of the magnet coil system

R1 resistance of the first network

R2 resistance of the second network

S1 switch of the flux pump

S2,S3 switch in the network

CL superconducting current limiter

We claim:

1. A magnet configuration comprising:
a superconducting magnet coil system having a working volume and an ohmic resistance of zero or more during operation thereof;
at least one current path, said current path including at least parts of said magnet coil system, said current path having current path connecting points;
a power supply having power supply connecting points; and
at least one first electric network, said first network having first network connecting points facing away from said power supply which are connected to said current path connecting points, said first network having first network connection points facing said power supply which are connected to said power supply connecting points, said first network also having at least one first resistance and at least one first inductance, wherein said first network connecting points facing away from said power supply are connected to each other via said first resistance and said first network connecting points facing said power supply are connected to each other via said first resistance and said first inductance.

2. The magnet configuration of claim 1, further comprising at least one second network having second network connecting points facing said power supply which are connected to said first network connecting points facing away from said power supply, said second network also having connecting points facing away from said power supply which are connected to said current path connecting points, wherein said second network comprises at least one second inductance and at least one second resistance, wherein said second network connecting points facing away from said power supply are connected to each other via said second resistance and said second network connecting points facing said power supply are connected to each other via said second resistance and said second inductance.

3. The magnet configuration of claim 1, wherein said first inductance of said first network is formed by a superconducting coil.

4. The magnet configuration of claim 1, wherein said power supply is an active current source.

5. The magnet configuration of claim 1, wherein said power supply is a flux pump.

6. The magnet configuration of claim 1, wherein said first inductance of said first network is largely inductively decoupled from said magnet coil system.

7. The magnet configuration of claim 1, wherein said first inductance of said first network is disposed to reduce a stray field thereof in the working volume.

8. The magnet configuration of claim 1, wherein said first inductance of said first network comprises a coil which has a shielding winding to minimize a stray field thereof.

9. The magnet configuration of claim 2, wherein said first and said second inductance each comprises at least one coil which is spatially disposed in such a manner that an overall field thereof in the working volume is minimized.

10. The magnet configuration of claim 1, wherein a time constant of said first network is a same order of magnitude or larger than a time duration of a largest fluctuation amplitude of a voltage or current of said power supply.

11. The magnet configuration of claim 1, further comprising a switch connected in series with said first resistance of said first network.

12. The magnet configuration of claim 11, wherein said switch is disposed outside of a cryostat in a room temperature region thereof.

13. The magnet configuration of claim 11, wherein said switch is a superconducting switch.

14. The magnet configuration of claim 1, further comprising a superconducting current limiter connected in series with said first resistance of said first network.

15. The magnet configuration of claim 1, wherein said superconducting magnet coil system is part of an apparatus for nuclear magnetic resonance.

16. The magnet configuration of claim 1, wherein said superconducting magnet coil system comprises one or more high-temperature superconductor coils.

17. A method for operating the magnet configuration of claim 11, wherein said switch of said first network is opened for charging said superconducting magnet coil system.

18. A method for operating the magnet configuration of claim 1, wherein an energizing current of said power supply is adjusted in such a manner that a magnetic drift caused by said ohmic resistance of said magnet system is largely compensated for.

19. The method for operating the magnet configuration of claim 18, wherein a current of said power supply is larger than a current in said current path.

20. A method for operating the magnet configuration of claim 1, wherein a voltage from said power supply, which is pulsed or varied in time, is adjusted in such a manner that an average time value thereof largely compensates for a drift caused by said ohmic resistance of said magnet system.
